(19) United States
(12) Patent Application Publication
(10) Pub. No.: US 2002/0049702 A1
(43) Pub. Date: Apr. 25, 2002

(54) System and method for creating customized documents for cross media publishing

(76) Inventors: Jacob Aizikowitz, Haifa (IL); Israel Roth, Ra'anana (IL); Reuven Sherwin, Ra'anana (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/775,502

(22) Filed: Feb. 5, 2001

Related U.S. Application Data
(60) Provisional application No. 60/180,120, filed on Feb. 3, 2000.

(51) Int. Cl. G06F 7/00

(52) U.S. Cl. 707/1

(57) ABSTRACT

A dynamic document and a method for representing a dynamic document are provided. The dynamic document includes a dynamic document template and an instances set abound to the dynamic document template. The instances set includes a plurality of pointers to a plurality of data sources. The dynamic document template includes a logic section and a layout section, the layout section having at least one layout object.

### CROSS REFERENCE TO RELATED APPLICATIONS

The application claims priority of US Provisional Patent Application 60/180,120, filed Feb. 3, 2000, entitled “A Method for Creating Dynamic Documents for Multi-Channel Publishing”, which application is incorporated in its entirety herein by reference.

### FIELD OF THE INVENTION

The present invention relates to the creation of dynamic variable-information documents.

### BACKGROUND OF THE INVENTION

Today, it is quite common to personalize documents with, for example, a reader's name or other information specific to one reader or a group of readers. An example is an advertising mass mailing that has been personalized with the addressee's name, offered goods, and special prices on the offered goods, all selected and calculated according to the addressee's past purchasing from the company making the offer, There exist tools, well known in the art, used to create these personalized documents. However, the prior art is (a) dependent on explicit programming or scripting to implement the personalization, (b) heavily dependent on specific rendering mechanisms (e.g., some print-related solutions are tightly integrated with specific properties and capabilities of specific printing systems), and (c) have no clean and modular definition of the relationship between the inherent parts of such documents—the design aspects, personalization logic aspects, and data (e.g., database) aspects.

World Wide Web (web) Documents

Tools such as Dreamweaver (available from Macromedia, Inc., San Francisco, Calif., USA), GoLive (available from Adobe Systems Inc., San Jose, Calif., USA), and others support the creation of personalized documents by allowing explicit insertion into the HTML code, so that they generate programming code (e.g., JavaScript) or database queries.

There is no convenient way of replacing the layout without “replacing” some of the personalization code. Moreover, the only way to have several different documents that will share the same logic is by explicit copying of the code that implements the logic from one HTML to the other.

Finally, the personalization logic is implemented partly by the programming or scripting code that is embedded explicitly into the HTFML and partly by references that such code makes into external systems (most typically database systems) that have in them the other parts of the logic in a form of, for example, SQL queries. Thus, there is no easy way to see or modify in one place the personalization logic that drives the generation of the personalized documents.

Print Documents

Numerous solutions exist that are highly integrated with and dependent on a specific printing system. These include Begin and its derivatives (available from Scitex Digital Printing, Dayton, Ohio, USA), VIPP (available from Xerox, Stamford, Conn., USA), and others. They all require significant preprocessing of the data from, for instance, the database, so that it fits exactly the structure needed to quickly feed the printing press, and they all have explicit programming in order to assemble personalized documents. They have no single desktop authoring tool, such as QuarkXPress (available from Quark, Inc., Denver, Colo., USA), that integrates all aspects of the personalized document and supports creation, revision, proofing in a full visually based environment. They support only a specific printing press, not to mention that they do not support non-print media types, such as the web.

Other, more desktop-oriented tools, exists as well. These include tools such as Darwin (available from CreoScitex, Burnaby, British Columbia, Canada), PrintShopMail (available from Atlas Software B. V., Harderwijk, The Netherlands) and mPower (available from PageFlex, Inc., Cambridge, Mass., USA). Although these tools provide a desktop-oriented environment for the authoring of personalized documents and support more generic print-related formats for output (e.g., PostScript (available from Adobe Systems, Inc.), PDF (Portable Document Formula) (available from Adobe Systems, Inc.), VPS (Variable Print Specification) (available from CreoScitex), or PPML (Personalized Print Markup Language) (available from Print On Demand Initiative, West Henrietta, N.Y., USA)), they do it at the expense of the type of personalization logic they support, the generality of their connectivity to database systems, and their production efficiency in generating output formats.

### SUMMARY OF THE INVENTION

The present invention relates to a method for representing a dynamic document, which is an application-independent digital representation of all possible personalized instances of that document. The present invention provides the flexibility and modularity of the representation described herein, which (a) separates personalization logic, layout designs, and personalization data, and (b) allows modifying one without necessarily affecting the other.

There is thus provided, in accordance with an embodiment of the present invention, a dynamic document, which includes a dynamic document template and an instances set bound to the dynamic document template.

Furthermore, in accordance with an embodiment of the present invention, the instances set includes a plurality of pointers to a plurality of data sources.

Furthermore, in accordance with an embodiment of the present invention, the data sources include one of a group including database data and media items.

In addition, there is provided a dynamic document template, which includes a logic section and a layout section. The layout section includes at least one layout object.

Furthermore, in accordance with an embodiment of the present invention, the logic section includes a set of dynamic objects, a set of data values and a set of rules for assigning the data values to the dynamic objects.

Furthermore, in accordance with an embodiment of the present invention, the set of rules is defined in terms of Relational Algebra.

Furthermore, in accordance with an embodiment of the present invention, the dynamic objects comprise a storage system for content items, the storage system being operable to receive requests for items in a form of a reference and to reply with an actual item.

Furthermore, in accordance with an embodiment of the present invention, the data values are one of a group including database items and media items. The instances sets may be assigned to the data table. The instances sets may be of a different type from the data tables.

Furthermore, in accordance with an embodiment of the present invention, the data values are defined as Relational Database tables.

Furthermore, in accordance with an embodiment of the present invention, the layout objects are represented in either a vendor neutral format, or native format of a layout tool, and wherein the layout tool is indicated by the type of the object.

Additionally, there is provided, in accordance with an embodiment of the present invention, a method for representing a dynamic document. The method includes the steps of:

providing a dynamic document template; and

binding an instances set to the dynamic document template.

Furthermore, in accordance with an embodiment of the present invention, the step of providing further includes the steps of:

describing a set of layout designs; and

defining the logic plan of the dynamic document template.

Furthermore, in accordance with an embodiment of the present invention, the layout design may be amended without amending the logic plan.

Furthermore, in accordance with an embodiment of the present invention, the step of defining further includes the steps of:

defining a set of dynamic objects for inclusion in the dynamic document;

defining a set of data values; and

defining a set of rules for assigning the data values to the dynamic objects.

Furthermore, in accordance with an embodiment of the present invention, the step of describing further includes the steps of:

providing a set of layout objects, the layout objects represented in either a vendor neutral format, or native format of a layout tool, wherein the layout tool is indicated by the type of the object;

providing a set of possible pages in the dynamic document; and

providing a set of place holders for the dynamic objects.

Furthermore, in accordance with an embodiment of the present invention, the step of binding includes the step of assigning the instances sets to database tables.

### BRIEF DESCRIPTION OF THE DRAWINGS

The present invention will be understood and appreciated more fully from the following detailed description taken in conjunction with the appended drawings in which:

FIG. 1A is a schematic illustration of an exemplary dynamic document template, constructed and operative in accordance with an embodiment of the present invention;

FIG. 1B is a schematic illustration of a particular instance of an exemplary dynamic document, constructed and operative in accordance with an embodiment of the present invention;

FIG. 2 is block diagram illustration of a dynamic document, constructed and operative in accordance with an embodiment of the invention; and

FIG. 3 is a block diagram illustration of another exemplary dynamic document template, constructed and operative in accordance with a further embodiment of the present invention.

### DETAILED DESCRIPTION OF THE PRESENT INVENTION

Applicants have devised a system containing knowledge about the contents of a document. Using this knowledge, a series of customized document instances may be created from a single “dynamic variable-information document” (herein referred to as dynamic document). The dynamic document in effect includes within the document itself instructions on how to make versions of documents. This includes not only static information about the document but also information needed to construct and incorporate the content of the dynamic parts of the document. Thus, a dynamic document allows the creation of a set of documents from a single dynamic document.

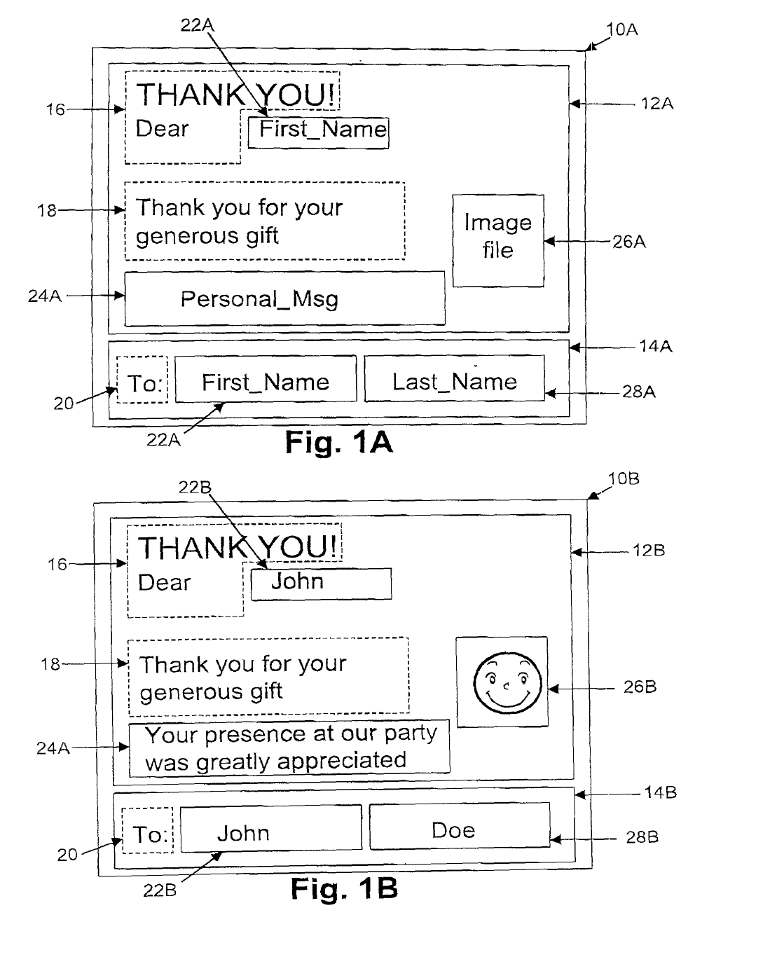

Reference is now made to FIGS. 1A and 1B. FIG. 1A is a schematic representation of an exemplary dynamic document template, “thanks doc” 10A, constructed and operative in accordance with an embodiment of the present invention FIG. 1B is a schematic representation of a particular instance “john doc” 10B of thanks doc 10A of FIG. 1A, which was constructed by a method operative in accordance with an embodiment of the present invention. All elements that are identical in both FIGS. 1A and 1B are indicated by dashed boxes and are labeled with the same numbers. Elements that are different are indicated by solid lines and labeled with numbers suffixed by A or B.

“thanks doc” 10A is comprised of a body section 12A and an address section 14A. Similarly, john doc 10B is comprised of a body section 12B and an address section 14B. Body sections 12A and 12B of FIGS. 1A and 1B both contain identical elements 16 and 18. These are static sections of the dynamic document that are comprised of static objects and are the same in all the generated instances of the document. Thus, the words “Thank you for your generous gift.” (element 18) appear in both documents 10A and 10B. However, body sections 12A and 12B additionally comprise elements that are different. Body section 12A comprises elements first name 22A, personal msg 24A, image file 26A, and last name 28A, whereas body section 12B comprises element John 22B “You presence at our party was greatly appreciated.” 24B, and a “smiley face” 26B.

Address sections 14A and 14B both comprise three elements. Element “To:” 20 is identical in both, since it is also a static part of the dynamic document. Address section 14A additionally comprises first name 22A, which is the same as in body 12A, and last name 28A. Address section 14B, on the other hand, comprises John 22B (again as in body 12B) and Doe 28B.

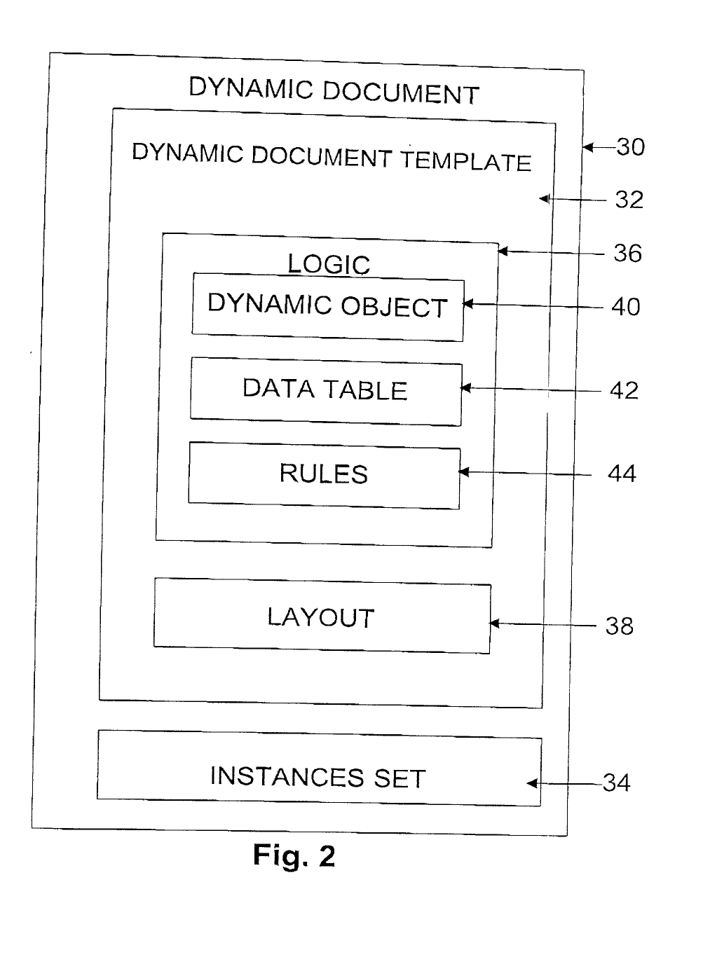

Static objects, those with no suffix added to the label number, are defined in the layout or design section of the dynamic document as described hereinbelow with respect to FIG. 2.

Elements that were suffixed with an “A” in thanks doc 10A are dynamic objects that are replaced with specific values in any given instance, for example john doc 10B, as describe in detail hereinbelow with respect to FIG. 2. Thus, first name 22A is replaced by John 22B, and image file 26A is replaced by a smiley face 26B. Furthermore, as described hereinbelow, elements 22B and 28B of address section 14B may be concatenated and used in finding the email address of “John Doe”.

Exemplary dynamic document template thanks doc 10A defines a representation that is independent of any particular implementation of data management or page layout. A dynamic document does not include its “publication” information internally, and therefore such a representation may be used for creating and producing dynamic documents across a variety of publishing media, for example, the World Wide Web (web), e-mail, and digital printing.

The value and significance of using an abstract notion of a dynamic document as a cornerstone for solutions in personalized publishing can be derived from the central role that the abstraction of a document plays in the discipline of desktop publishing. Desktop publishing uses the “What you see is what you get” (WYSIWYG) model, which is well known in the art. The idea promulgated in the WYSIWYG model is that the user simply creates a visual rendering of the document that will be produced. It is the job of the desktop publishing application to translate its internal representation language into any of the representations recognized by print systems. The unique theme of the method of the present invention is that it defines abstraction, representation, and processes that can be applied in cross-media personalized publishing solutions.

As mentioned hereinabove, a dynamic document is a single entity that represents many “regular” documents, hereinbelow referred to as document instances. An exemplary document instance is FIG. 1B. The dynamic document stores not only the static information of the pages of the document but also information needed to construct the content of the dynamic parts of any page. It also indicates how to incorporate each dynamic item into the page layout (e.g., location, scale, fit, etc.).

Reference is now made to FIG. 2, a schematic representation of a dynamic document 30. A dynamic document, constructed and operative in accordance with an embodiment of the present invention, comprises a dynamic document template 32 and an instances set 34.

Dynamic document template 32 comprises a logic section 36 and a layout section 38. Logic section 36 describes the schema that a database or other data depository must have in order to be used with dynamic document 30. Layout section 38 comprises at least one layout object that indicates the appearance of an actual instance of a particular dynamic document page. Instances set 34 comprises a plurality of pointers to data sources of various types, including for example, database data and media items, which may be used to populate the instances of dynamic document 30, as described hereinbelow.

Layout section 38 comprises a collection of layout objects that show page designs of dynamic document 30. If, for example, a document comprises two pages, then layout section 38 will contain two layout objects, one for the first page and another for the second page. Thus if there exist K different layouts for the first page and M different layouts for the second page, there will be K+M layouts. Thus, layout section 38 comprises all the possible variations of document layouts. These may be represented in either a vendor neutral format, such as HTML (Hyper Text Markup Language), XML (Extensible Markup Language) and XSL (Extensible Style Language], or the native format of a page layout application. Examples of page layout applications are Adobe's InDesign, and Quark's QuarkXpress. Others include Adobe's GoLive, Macromedia's Dreamweaver, or Microsoft's FrontPage, which are all web-oriented and use HTML or XML as their native formats. Each layout object defines both the static objects and the areas that should be “populated” with dynamic content. Dynamic objects refer to the items that may be needed by the dynamic areas of layout objects in layout section 38. Referring to thanks doc 10A of FIG. 1, for example, layout section 38 has a single layout object for this dynamic document 30. This layout has a place for a person's name, indicated by first name 22A, and a place for a personalized picture, indicated by image file 26A. In this case, the layout object uses two dynamic objects, first name and image file. The first is of type “text” and the other is of type “image”.

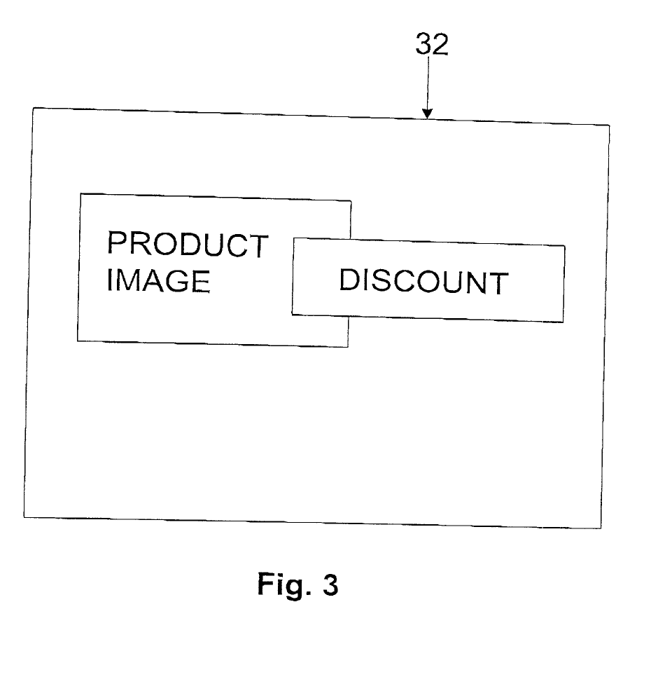

Reference is now briefly made to FIG. 3, which is a block diagram illustration of a dynamic document template 32, comprising two dynamic objects, “product image” and “discount”. It should be noted that these object overlap. There are no restrictions on the number of dynamic objects used by a given layout object, nor on their placement relative to either static objects or other dynamic objects being used by the same layout. Dynamic document 30 is able to handle layered static and dynamic objects correctly by presenting the layering order for use in creating proofing views or in generating final, target media-specific, rendering instructions.

Layout section 38 also indicates where each dynamic object should be placed and how. The term “placeholder(s)” is used hereinbelow to refer to this information. Placeholders may be implicit, as indicated by layout section 38, or explicit, as stored in logic section 36. In either case, however, the source for placeholders is layout section 38.

Logic section 36 is comprised of a dynamic object section 40, a data table section 42, and a rules section 44. Dynamic object section 40 defines the dynamic objects that may appear in any page and instance of a dynamic document 30. Only dynamic objects, for example first name 22A (FIG. 1A), are defined in dynamic object section 40. Static sections, for example “To:” 20 (FIGS. 1A and 1B), are not defined in logic section 36 but rather appear as part of a layout object in layout section 38. The definition of a dynamic object comprises its name and possible types.

Data table section 42 comprises logical tables defining the schema of actual data tables or data sets appropriate for use with dynamic document 30. The actual tables are part of instances set 34. The definition of a logical table comprises a table (or set) name and the attributes of the records of the table (or set). The definition of the attributes includes the attribute name and type. There may be a plurality of logical tables in data table section 42, in which case one is considered the main table and is referred to hereinbelow as the key list table. (In certain cases this table may be referred to as the “prime set” or “primary table”.)

Rules section 44 contains a set of rules that state how to associate values for dynamic objects. Typically, these rules are stated in terms of the logical tables and the attributes of their records. However, other formalisms are possible, including making references to external systems. The rules are assignment statements (to use a term from programming languages) that use some expression logic. In an embodiment of the invention, the expression logic is based on Relational Algebra.

Thus, rules section 44 comprises a set of rules in any formal logic, which are used in the creation of document instances. Firstly, rules section 44 includes rules governing which layout object from layout section 38 to choose for a given instance of a given page. This rule is optional; not all representations of dynamic document 30 support such a rule, if “layout rules” do not exist, layout section 38 contains one layout object for the given page.

Rules section 44 also comprises rules as to the value to assign to each dynamic object used by the chosen layout.

Exemplary rules of mappings are of the type:

Data×Layout×DynamicContent→Instance_Layouts×Instance_DynamicContent

where Instance_Layout and Instance_DynamicContent represent the range of possible layout objects and content objects per document instance. In other words, given a record from the key list table, the mapping may use any appropriate data from data table section 42 with each element from layout section 38 and likewise, appropriate other data from data table section 42 with elements in dynamic object section 40. Thus, the rules assign values to the layout instances and the dynamic objects of the document instance.

For example, assume that data table section 42 consists of two logical tables: “Citizens”, comprising information about citizens of a certain country, including their addresses; and “Maps”, comprising records with two attributes each, a zip code and a “map reference”. Instances set 34 comprises pointers to the actual Citizens and Maps tables, as well as to the collection of map images. Furthermore, assume that the collection of map images is identified by keys of the same type given in the map reference attribute of the Maps table, Finally, assume that layout section 38 has two possible page layout objects, one for singles and one for families. (It is assumed that the records of the Citizens table include marital status as an attribute and that this attribute can be used to determine whether a singles or families layout object will be used). Given a record of a specific citizen, C, the rules will first use the value of the marital status attribute to determine the layout object. Given a selected layout object, it is possible to find out the dynamic objects needed by this specific layout object. For simplicity, in this example we assume that the two possible layout objects need exactly the same set of dynamic objects. The rule will derive C's zip code from C's address and, based on the zip code value, will locate a record, say R, in Maps where the value of R's zip code equals the value of C's zip code, and retrieve the value of R's map reference attribute. Based on the map reference value the rule will choose from instances set 34 an a image of a map that covers the desired zip code.

As seen in the example hereinabove, instances set 34 comprises pointers to various data sources. These data sources include, for example, data stored in a database as well as “media” sources that may be stored, for example, in a folder of media files or in a media asset management system (MAM). A MAM is a system that handles the storage and retrieval of media assets, for example, images, text segments, page layouts, movie clips, or clip art objects.

The value of a dynamic object may be given directly or indirectly. If the value is given directly, it is the direct result of evaluating a rule. If the value is given indirectly, the rules will determine a value that is only a reference to the real value. The simplest case of a reference value is a file name or URL that identifies the actual value of the content object. A more complex case is when the reference is a key that can be “presented” to an optional MAM, which will respond with the actual value of the content object.

The unique features of the method of the present invention, as well as its novelty, are not in the definitions of these terms but rather in the decision to make these identifiable elements of the architecture and the specifics of combining these into a single object that represents a dynamic document.

In an embodiment of the present invention, the information of dynamic document 30 is built up in a series of files. The first file is called a “plan” file. It comprises the elements of logic section 36 of dynamic document 30. Dynamic object section 40 contains statements that declare the dynamic objects. Data table section 42 contains definitions of the data found in dynamic document 30. For example, these definitions may describe a database table and its fields. Alternatively, they may describe appropriate image files. Finally, rules section 44 contains the assignment statements assigning data to dynamic objects.

The second file is called a “vdot” file, It corresponds to dynamic document template 32 and its role is similar, for example, to the one of a “.dot” file in Microsoft Word. Layouts section 38 comprises a series of layout descriptions. This includes the code describing where objects will appear within is the design layout and how they will appear. It also gives the names of placeholders in the layout that will be substituted by values of dynamic objects when the dynamic document instances are produced. It also contains a reference to the plan file, thus forming dynamic document template 32.

To define an actual dynamic document 30, the .vdot file must be bound to an instances set 34. Instances set 34 comprises the actual pointers to real data sources that match the defined data requirements in data table section 42. Changing instances set 34 will result in a different dynamic document 34.

It is noted that other embodiments are possible using different file combinations and are included within the scope of this invention. Any combination that results in the ability to create dynamic documents 30 as disclosed hereinabove is included within the scope of this invention.

A unique capability provided by the method of the present invention is the ability to assign instances sets 34 to data table 42, where the instances sets 34 are not necessarily of the same type defined by data table 42. If data table 42 defined, for example, a given set of tables with a given set of record attributes per table, then assigning instances sets 34 of the same type to data table 42 is straightforward. Assigning instances sets 34 of different types (i.e., different tables, different attributes, etc.) in a straightforward manner is impossible. However, by providing a mapping function that maps the elements of a particular instances set 34 to the elements of data table 42 (an operation that is similar to “casting” in programming languages), such an assignment becomes possible. To use database terminology, if a given database (DB) does not have exactly the tables defined in data table 42, then it is possible to define the views that will map the database tables to those expected by data table 42.

The capability to create another dynamic document simply by “attaching” another source for data through instances sets 34, without any need to change logic section 36 is unique. This flexibility of attaching instances sets 34 allows, for example, the assignment of data for design, design proofs, etc. Such an assignment need not be part of a commercial-grade systems. Once production phase starts, it is possible to attach, through the instances sets 34, a commercial-grade system with the production values.

Another flexibility derived from the modularity of the representation of dynamic document 30 is the ability to use many different types of layout mechanisms (engines). In other words, it is possible to create many different layout sections 38 for a given dynamic document 30. Layout sections 38 that are based on a single layout engine can be defined. For example, QuarkXPress (available from Quark, Inc., Denver, Colo., USA) design type, or InDesign (available from Adobe Systems, Inc.) design types are possible. But so is a layout section 38 that uses different layout types for different pages. For example, the cover page can be defined using InDesign layout objects, and internal pages could be defined using QuakXPress format or HTML. This flexibility in the choice of design types is extremely important. It shows that the same personalization logic can be used with layouts that are print oriented and with layouts that are web oriented. Hence the cross-media capability of the method.

Another layout-related flexibility is the ability to change the layouts from one style to another and thus modify the look and feel of dynamic document 30 without redoing logic section 36. This requires re-assigning dynamic objects to areas and places in the new layout, which must be of the same type as the assigned dynamic object, but leaves the logic intact.

It will be appreciated by persons skilled in the art that the present invention is not limited by what has been particularly shown and described hereinabove. Rather the scope of the invention is defined by the claims that follow.

What is claimed is:

1. A method for representing a dynamic document, comprising the steps of:
providing a dynamic document template; and
binding an instances set to said dynamic document template.

2. A method according to claim 1, wherein said step of providing further comprises the steps of:
describing a set of layout designs; and
defining the logic plan of said dynamic document template.

3. A method according to claim 2, wherein said step of defining further comprises the steps of:
defining a set of dynamic objects for inclusion in said dynamic document;
defining a set of data values; and
defining a set of rules for assigning said data values to said dynamic objects.

4. A method according to claim 3, wherein said data values are one of a group including database items and media items.

5. A method according to claim 3, wherein said step of describing further comprises the steps of:
providing a set of layout objects, said layout objects represented in either a vendor neutral format, or native format of a layout tool,
wherein said layout tool is indicated by the type of said object;
providing a set of possible pages in said dynamic document; and
providing a set of placeholders for said dynamic objects.

6. A method according to claim 3, wherein said set of rules are defined in terms of Relational Algebra.

7. A method according to claim 3, wherein said dynamic objects comprise a storage system for content items, said storage system being operable to receive requests for items in a form of a reference and to reply with an actual item.

8. A method according to claim 4, wherein said data values are defined as Relational Database tables.

9. A method according to claim 4, wherein said step of binding comprises the step of assigning said instances sets to said database tables.

10. A method according to claim 2, wherein said step of providing further comprises the step of amending said layout design while not amending said logic plan.

11. A dynamic document template comprising:
a logic section; and
a layout section comprising at least one layout object.

12. The dynamic document template according to claim 11, wherein said logic section comprises:
a set of dynamic objects;
a set of data values; and
a set of rules for assigning said data values to said dynamic objects.

13. The dynamic document template according to claim 12, wherein said set of rules is defined in terms of Relational Algebra.

14. The dynamic document template according to claim 12, wherein said dynamic objects comprise a storage system for content items, said storage system being operable to receive requests for items in a form of a reference and to reply with an actual item.

15. The dynamic document template according to claim 12, wherein said data values are one of a group including database items and media items.

16. The dynamic document template according to claim 12, wherein said data values are defined as Relational Database tables.

17. The dynamic document template according to claim 11, wherein said layout objects are represented in either a vendor neutral format, or native format of a layout tool, and wherein said layout tool is indicated by the type of said object.

18. A dynamic document comprising:
a dynamic document template; and
an instances set bound to said dynamic document template.

19. The dynamic document according to claim 18, wherein said instances set comprises a plurality of pointers to a plurality of data sources.

20. The dynamic document according to claim 19, wherein said data sources comprise one of a group including database data and media items.

21. The dynamic document according to claim 18, wherein said dynamic document template comprises:
a logic section; and
a layout section comprising at least one layout object.

22. The dynamic document according to claim 21, wherein said logic section comprises:
a set of dynamic objects;
a set of data values; and
a set of rules for assigning said data values to said dynamic objects.

23. The dynamic document according to claim 22, wherein said set of rules is defined in terms of Relational Algebra.

24. The dynamic document according to claim 22, wherein said dynamic objects comprise a storage system for content items, said storage system being operable to receive requests for items in a form of a reference and to reply with an actual item.

25. The dynamic document according to claim 22, wherein said data values are one of a group including database items and media items.

26. The dynamic document according to claim 22, wherein said data values are defined as Relational Database tables.

27. The dynamic document according to claim 26, wherein said instances sets are assigned to said database tables.

28. The dynamic document according to claim 27, wherein said instances sets are of a different type from said database tables.

29. The dynamic document according to claim 21, wherein said layout objects are represented in either a vendor neutral format, or native format of a layout tool, and wherein said layout tool is indicated by the type of said object.
